(19) United States
(12) Patent Application Publication
(10) Pub. No.: US 2026/0236719 A1
(43) Pub. Date: Aug. 13, 2026

(54) USING A FINE-TUNED LARGE LANGUAGE MODEL (LLM) TO VALIDATE TRANSLATIONS

(71) Applicant: International Business Machines Corporation, Armonk, NY (US)

(72) Inventors: Yin Xia, Beijing (CN); Jun Su, Beijing (CN); Douglas Brian Mueller, Apex, NC (US); Peng Hui Jiang, Beijing (CN)

(21) Appl. No.: 19/052,098

(22) Filed: Feb. 12, 2025

(51) Int. Cl. G06F 40/51; G06F 40/58

(52) U.S. Cl. CPC G06F 40/51; G06F 40/58

(57) ABSTRACT

A method, according to one approach, includes retrieving, from a knowledge graph, first information associated with first resources in a source language, and using the first information to generate sentences that detail a context of the first resources and relationships that the first resources have with second resources. The method further includes causing a fine-tuned large language model (LLM) to grade a first translation element, where the first translation element is a translation of a first portion of the first resources to a target language. The method further includes using the grade to validate the first translation element. A computer program product, according to another approach, includes one or more computer-readable storage media, and program instructions stored on the one or more storage media to perform the foregoing method.

### BACKGROUND

The present invention relates to linguistics, and more specifically, this invention relates to large language models (LLMs).

A variety of different languages are spoken throughout the world. Technological advances have enabled people in different geographical areas to communicate with one another. In order to prevent different languages from limiting communication between two or more people, communications are sometimes translated from a source language, (e.g., a dialect of a speaker) to a target language (e.g., a dialect of a listener listening to the speaker).

In some use cases, communications are translated from a source language to a target language by computers. For example, a computer may be used to translate plain-text resource files and/or bundles from a source language of a first user to a target language of a second user and vice versa.

### SUMMARY

A method, according to one approach, includes retrieving, from a knowledge graph, first information associated with first resources in a source language, and using the first information to generate sentences that detail a context of the first resources and relationships that the first resources have with second resources. The method further includes causing a fine-tuned large language model (LLM) to grade a first translation element, where the first translation element is a translation of a first portion of the first resources to a target language. The method further includes using the grade to validate the first translation element.

A computer program product, according to another approach, includes one or more computer-readable storage media, and program instructions stored on the one or more storage media to perform the foregoing method.

A computer system, according to another approach, includes a processor set, one or more computer-readable storage media, and program instructions stored on the one or more storage media to cause the processor set to perform the foregoing method.

Other aspects and approaches of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach of the present invention.

FIG. 2 is a flowchart of a method, in accordance with one approach of the present invention.

FIG. 3 is a logical framework, in accordance with one approach of the present invention.

FIG. 4 is a flowchart of a method, in accordance with one approach of the present invention.

FIG. 5 is a knowledge graph with representations of relationships, in accordance with one approach of the present invention.

FIG. 6 is a flowchart of a method, in accordance with one approach of the present invention.

FIG. 7 is a flowchart of a method, in accordance with one approach of the present invention.

FIG. 8 is a flowchart of a method, in accordance with one approach of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for using a fine-tuned LLM to validate translations.

In one general approach, a method includes retrieving, from a knowledge graph, first information associated with first resources in a source language, and using the first information to generate sentences that detail a context of the first resources and relationships that the first resources have with second resources. The method further includes causing a fine-tuned large language model (LLM) to grade a first translation element, where the first translation element is a translation of a first portion of the first resources to a target language. The method further includes using the grade to validate the first translation element.

A technical effect of using the operations described above to determine and incorporate contextual relationships of resources during the process of using an LLM to translate resources from a source language to a target language includes streamlining into the translation of the resources. This contextual validation also increases the accuracy and performance of machine translation for software interfaces because manual errors are not introduced to the translation as the techniques described herein do not involve manual intervention.

The method may further include creating the fine-tuned LLM, where creating the fine-tuned LLM includes obtaining second information for a product page associated with the first resources. The second information may be selected from a group including documents, existing resources, and previously performed corresponding translations. Creating the fine-tuned LLM may further include using the second information to tune a base LLM to create the fine-tuned LLM.

A technical effect of creating the fine-tuned LLM includes refinement of an accuracy of the base LLM. More specifically, the fine-tuned LLM is specifically tuned to enable the performance and accuracy of translation validation to be enhanced. By fine-tuning the LLM before using the LLM, an accuracy of the LLM is ramped up in a controlled training setting rather than otherwise prematurely deploying an LLM before a threshold degree of accuracy is achieved (as a result of the fine-tuning).

The first resources may include a plurality of portions including the first portion. The first information may include subject-predicate-object strings, and the strings may be associated with the portions.

A technical effect of the first information including subject-predicate-object strings that are associated with the portions includes establishment of a concise description of context, that is uniform for each of the different portions. The conciseness of the first information (in the form of subject-predicate-object strings) also has a technical effect of ensuring that a storage size of first information is predictable when scaling-out the knowledge graph.

Predefined templates may be applied to use the first information to generate the sentences that detail the context of the first resources and the relationships that the first resources have with the second resources.

A technical effect of using predefined templates to generate the sentences from the first information includes a reduction in an amount of processing that is consumed (such as by an artificial intelligence (AI) model used to generate the sentences) in generating the sentences. In other words, the predefined templates serve as a guide for how to generate the sentences rather than the sentences being generated without any such guidance.

The method may further include creating the knowledge graph. The creating the knowledge graph may comprise defining concepts of a product page associated with the first resources as entities in the knowledge graph, identifying relationships between the entities, and representing the identified relationships as edges in the knowledge graph.

A technical effect of creation of the knowledge graph includes organization of information that is referenced by the fine-tuned LLM as context to validate translations of resources. As a result of incorporation of this context to such a validation, inaccurate translations (as a result of mis-context) are able to be identified, rather than being allowed to proceed in a use case environment. Otherwise allowing these mistranslations to proceed would otherwise result in confusion during use of the product, which ultimately leads to additional computer processing being performed to identify the inaccuracies. Accordingly, the creation of the knowledge graph enables a reduction in computer processing associated with translating products such as software products.

The creating the knowledge graph may further include enriching the knowledge graph. The enriching may include adding attributes specific to the product page to the knowledge graph. The attributes may be selected from a group including Hypertext Markup Language (HTML) attributes, technical specifications, use cases, and performance characteristics.

Enrichment of the knowledge graph has a technical effect of refining an accuracy of the fine-tuned LLM over time in order to reduce an overall amount of work that is performed when validating a translation element (this also increases a work potential of a user device performing operations described herein).

The concepts may be selected from a group including features, functionalities, and components. The knowledge graph may be a virtual knowledge graph.

A technical effect of having a plurality of concepts includes a diversification of the knowledge graph and refinement of an accuracy of the validation of translations (based on the plurality of concepts considered for context).

The grade of the fine-tuned LLM may include a numerical score and natural language descriptions detailing the grade. The method may further include determining whether the numerical score exceeds a predetermined validation threshold, and in response to a determination that the numerical score does not exceed the predetermined validation threshold, determining a replacement translation element to replace the first translation element with.

A technical effect of using a numerical score for validating a translation includes establishment of a uniform threshold that each translation element is gauged against.

The numerical score may be based on a specific factor associated with a product page associated with the first resources, where the specific factor may be selected from a group including a linguistic style of the product page, conventions of the product page, a tone of the product page, and an overall historical user experience of the product page.

A technical effect of having a plurality of factors that the numerical score is based on includes the addition of detail and diversification into the grade of the first translation element.

The method may further include iteratively performing a refinement process on the knowledge graph to increase an accuracy of the fine-tuned LLM over time. The iteratively performing the refinement process on the knowledge graph may include employing rule-based reasoning and consistency checking mechanisms to validate an integrity and coherence of the knowledge graph.

Increasing an accuracy of the fine-tuned LLM over time has a technical effect of reducing an overall amount of work that is performed when validating a translation element. This also increases a work potential of a user device performing operations described herein.

In another general approach, a computer program product includes one or more computer-readable storage media, and program instructions stored on the one or more storage media to perform the foregoing method. Similar technical effects are obtained.

In another general approach, a computer system includes a processor set, one or more computer-readable storage media, and program instructions stored on the one or more storage media to cause the processor set to perform the foregoing method. Similar technical effects are obtained.

In another general approach, a method includes creating a fine-tuned LLM, creating a knowledge graph, and retrieving, from the knowledge graph, first information associated with first resources in a source language, and using the first information to generate sentences that detail a context of the first resources and relationships that the first resources have with second resources. The method further includes causing the fine-tuned LLM to grade a first translation element, where the first translation element is a translation of a first portion of the first resources to a target language. The method further includes using the grade to validate the first translation element.

A technical effect of creating the fine-tuned LLM includes refinement of an accuracy of the base LLM. A technical effect of creation of the knowledge graph includes organization of information that is referenced by the fine-tuned LLM as context to validate translations of resources. A technical effect of using the operations described above to determine and incorporate contextual relationships of resources during the process of using an LLM to translate resources from a source language to a target language includes streamlining into the translation of the resources. This contextual validation also increases the accuracy and performance of machine translation for software interfaces because manual errors are not introduced to the translation as the techniques described herein do not involve manual intervention.

In one preferred use case environment, the fine-tuned is deployed to grade a first translation element of a product page. The product page is preferably featured on a user interface, and screenshots of the product pages (pre and post translation from a source language to a target language) may be used to extract information in the process of validating one or more translation elements.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as validation code of block 150 for using a fine-tuned LLM to validate translations. In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

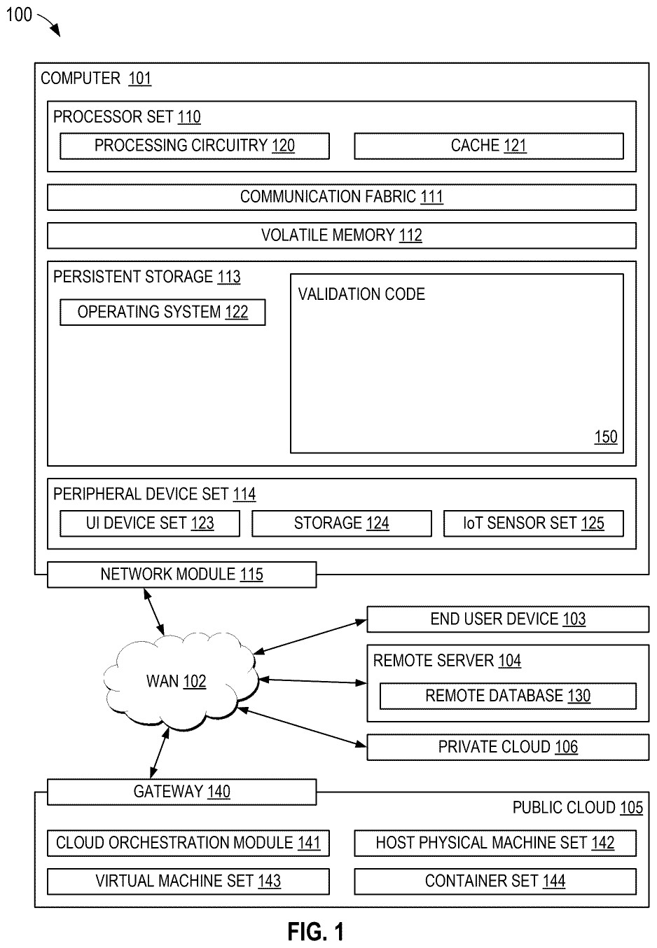

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip”. In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As previously mentioned elsewhere herein, a variety of different human languages are spoken throughout the world. Technological advances have enabled people in different geographical areas to communicate with one another. In order to prevent different languages from limiting communication between two or more people, communications are sometimes translated from a source language, (e.g., a written, verbal, etc. human language that may include: a dialect of a speaker, a native language of the speaker, etc.) to a target language (e.g., e.g., a written, verbal, etc. human language associated with a target person).

In some use cases, communications are translated from a source language to a target language by computers. For example, a computer may be used to translate plain-text resource files and/or bundles from a source language of a first user to a target language of a second user and vice versa. In some other use cases, software of a product is translated from a source language to a target language by a computer. To optimize a total efficiency of the software globalization process (the analysis of the software resources and translation of the software resources thereafter), the actual translation work for software is sometimes conducted within a dedicated translation management environment. The translation management environment may be distinctly separated from a live environment of the product (an environment in which the product is deployed and actively being used).

Translation tasks of a computer are typically performed on individual string items saved in resource files or bundles. The string items are translated independently one by one through machine translation workflows. However, this string by string analysis of plain-text resource files or bundles lacks an incorporation of contextual information and therefore amounts to merely a black-box translation process. This lack of contextual information sometimes (by considering only pure textual resources of a given sentence) leads to the same phrase or sentence having vastly different translations depending on the linguistic context. For example, the word “home” has a drastically different meaning when referring to a website as opposed to the structure a person lives in. For these reasons, use of conventional computer translation tools results in mistranslations because translations are performed on text without considering contextual information. This compromises the accuracy and applicability of translations. These mistranslations also amount to a waste of computer resources. Accordingly, there is a longstanding need within the technical field of computer processing for translation techniques that increase translation accuracies (thereby reducing wasteful computer resource operations) by considering contextual information of resources that are being translated from a source language to a target language.

In sharp contrast to the deficiencies described above, the techniques of approaches described herein determine and incorporate contextual relationships of resources during the process of using an LLM to translate resources from a source language to a target language. This incorporation streamlines and introduces efficiencies into the translation of the resources. It should be noted that when it comes to translating software interface content (such as a product page), the inherent fragmentation of interface content and weaker contextual relationships between the interface elements, compared to regular text such as articles or news pages, poses challenges that limit the effectiveness of LLMs for translation and/or translation validation. Consequently, the use of LLMs described herein to increase the accuracy and performance of machine translation for software interfaces is a non-obvious solution to the issues described above within the technical field of computer processing.

In order to mitigate the deficiencies described above, the techniques of approaches described herein provide techniques that enhance the performance and accuracy of translation validation based on LLMs when handling software interface content (such as software code that is maintained to support a product page), thereby reducing or even eliminating a manual post-editing workload and ultimately improving the overall efficiency and quality of software translations. One core idea of these techniques defines enhances the translation validation capabilities of LLMs for software products, by leveraging a Product Knowledge Graph (also referred to herein as a “knowledge graph” and/or “PKG” for a product) constructed from software documentation and information of user interface, to enhance the translation quality and translation validation of software products. The knowledge graph, in some approaches, preferably captures a hierarchical structure, relationships and logic information among user interface components, functionalities, and user-centric concepts of the software, providing valuable contextual information to the LLM and operations associated with the LLM. By integrating the knowledge graph into a translation validation workflow, the techniques described herein identify relevant entities and attributes for each software interface element, extracting crucial context such as product features, terminology, and usage scenarios. This extracted context is used to enrich the translation validation capability of a system associated with the LLM, ensuring translations of software interface align with a product's linguistic style and conventions. Accordingly, Product-Contextual Precision Translations (PCPT) may be generated, in some approaches.

The techniques described herein, in some approaches, additionally and/or alternatively implement a bidirectional validation process, where the translations or translation validation performed by the LLM are cross-referenced with the knowledge graph to identify any inconsistencies in terminology, tone, or style. This feedback loop not only ensures the translation quality but also provides insights for further improvements, enabling the continuous updating of the knowledge graph to ensure that the knowledge graph remains aligned with the evolution of an associated software product.

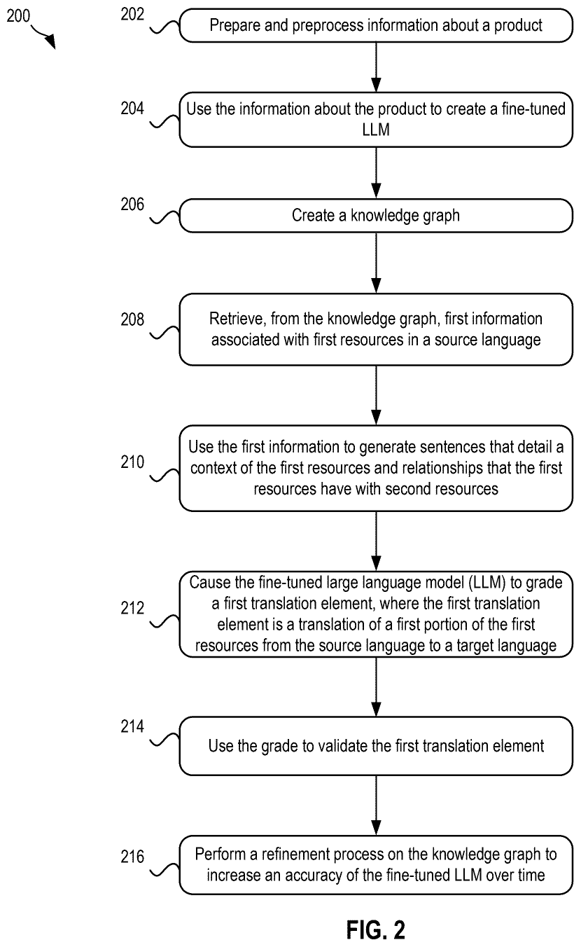

Now referring to FIG. 2, a flowchart of a method 200 is shown according to one approach. The method 200 may be performed in accordance with aspects of the present invention in any of the environments depicted in FIGS. 1-8, among others, in various approaches. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various approaches, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that operations of method 200 may be performed in order to ensure that a translation of at least a portion of resources from a source language to a target language is performed without errors based on missing context. The term resources, in some preferred approaches, may be defined as any section of a product page that includes elements in an identifiable language, e.g., a source language. These languages may be any type of language that would become apparent to one of ordinary skill in the art after reading the descriptions herein, e.g., characters, numbers, text, strings of words, etc. To provide additional context, the product page mentioned above and herein may be defined as a page, e.g., domain page, directory page, etc., that details a type of product of a type that would become apparent to one of ordinary skill in the art after reading the descriptions herein, e.g., software, a mechanism, a company, a service, etc. In some preferred approaches, the product is software code that is offered to customer user devices, and the resources are portions of a page associated with the product, e.g., a product page of the software. Accordingly, in some approaches, method 200 includes obtaining information for a product page associated with resources.

In some approaches, in order to prepare for generating a contextual understanding of the product, information about the product may be obtained and organized. For example, operation 202 includes preparing and preprocessing information about the product. In some approaches, preparation of the information includes gathering relevant product documentation, user manuals, technical specifications, design documents, user interface resources and/or other textual resources of a type of that would become apparent to one of ordinary skill in the art after reading the descriptions herein. In some approaches in which the product is a software product, this information preferably contains information about a software product's user interface and/or functionality. The information may be obtained from one or more sources of information, e.g., the web via use of a web crawler, input information, a database, etc.

Preparation of the information about the product may, in some approaches, include cleaning the information. The information about the product may additionally and/or alternatively be preprocessed in some approaches. The cleaning and/or preprocessing of the information about the product may be achieved by performance of one or more predetermined tasks, e.g., tokenization of the information, stop word removal, and lemmatization, etc., to prepare the information for LLM-based processing. These tasks may be of a type that would become apparent to one of ordinary skill in the art after reading the descriptions herein.

In some approaches, the resources may be determined to include more than a predetermined threshold number of elements, e.g., consecutive words, strings, numbers, etc. In some approaches, one or more of the resources and/or elements thereof, may be split the text into smaller, manageable chunks to facilitate processing. These chunks may be of a predetermined size, e.g., by paragraphs, by sections, a predetermined word count, a predetermined string size, etc.

Operation 204 includes creating a fine-tuned LLM. The information about the product is, in some preferred approaches, used to fine-tune the LLM subsequent to the information being obtained and/or organized. Creation of the fine-tuned LLM may, in some approaches, include initially selecting a base LLM to train (train by using the information). This base LLM, in some approaches, includes a pre-trained LLM, such as Bidirectional Encoder Representations from Transformers (BERT) and/or Generative Pre-trained Transformer 3 (GPT-3), which may be well-suited for the task of entity and relationship extraction. The selected base LLM may be fine-tuned with the information about the product. For example, in one approach, using the second information to tune the base LLM to create the fine-tuned LLM includes using documents about the product (obtained product documentation) for techniques such as transfer learning to adapt the base LLM's understanding of the product-specific vocabulary and concepts (thereby creating the fine-tuned LLM). The information about the product used to tune the base LLM may additionally and/or alternatively include existing resources, previously performed corresponding translations, and/or other types of information of a type that would become apparent to one of ordinary skill in the art after reading the descriptions herein. In some approaches, the existing product resources and corresponding translations may be based on information from other products determined to have at least a predetermined degree of similarity with the product. For example, in response to a determination that the information obtained about the product does not amount to at least a predetermined threshold of resources, information about these other products may be additionally and/or alternatively obtained and used.

The selected base LLM is, in some approaches, caused, e.g., instructed, to consume the information about the product to fine-tune the model to refine an accuracy of the LLM for identifying which specific content and terms associated with the product are capable of being translated. For example, this tuning may include causing the LLM to build a list of identifiable terms in a source language, where the identifiable terms are identified by the LLM during processing of the information about the product. The base LLM's performance may be refined through hyperparameter tuning and iterative refinement techniques of a type that would become apparent to one of ordinary skill in the art after reading the descriptions herein. This tuning and iterative refinement may be performed until a predetermined degree of accuracy is detected. At this point, the base LLM may be determined to be the fine-tuned LLM and be ready for deployment (to perform one or more operations described below).

The fine-tuned LLM may be caused, e.g., instructed, to perform entity and relationship extraction operations for identifying translatable content (translation elements) of the product. For example, these operations may include using the fine-tuned LLM to process the preprocessed data with advanced natural language understanding tasks. These tasks, in some approaches, include extracting key product features, components, and functionalities from textual data associated with the product. In some other approaches, these tasks may additionally and/or alternatively include identifying relationships between product components and functionalities. This identification may, in some approaches, be achieved by use of correlation and/or relationship matrices, context mining on one or more chat databases associated with the product, analyzing manuals associated with the product, etc. Context-specific product knowledge that may not be explicitly stated in the obtained product documentation and/or information mentioned above may additionally and/or alternatively be obtained by the fine-tuned LLM. This context-specific product knowledge is, in some approaches, may be obtained based on the fine-tuned LLM applying other information to deductive reasoning algorithms, using forecasting methods of a type that would become apparent to one of ordinary skill in the art after reading the descriptions herein, etc.

The advanced natural language understanding tasks may additionally and/or alternatively include natural language processing tasks (with an understanding focus) that focus on translatable content in the product (especially elements on the user interface). In some approaches, these tasks employ techniques such as named entity recognition and relation extraction to extract the structured data from the unstructured text within the resources of the product page. Rules may be developed by the fine-tuned LLM and/or additional models to infer implicit relationships and attributes based on the extracted entities and their contexts. Rule generating algorithms are used in some approaches to generate such rules.

A technical effect of creating the fine-tuned LLM includes refinement of an accuracy of the base LLM. More specifically, the fine-tuned LLM is specifically tuned to enable the performance and accuracy of translation validation to be enhanced. By fine-tuning the LLM before using the LLM, an accuracy of the LLM is ramped up in a controlled training setting rather than otherwise prematurely deploying an LLM before a threshold degree of accuracy is achieved (as a result of the fine-tuning).

Results of performing one or more of the tasks and/or operations described above may be used to create a knowledge graph. For example, operation 206 includes creating a knowledge graph. The creating the knowledge graph, in some approaches, comprises defining concepts of a product page associated with the first resources as entities in the knowledge graph. These concepts may be defined as a defined understanding about how the product page is navigated. In some approaches, these concepts define conceptual information about the navigation of the product page, e.g., text that may be selected to navigate to a “next” page. Another of such concepts that define conceptual information about the navigation of the product page includes a “home” selection button, which results in a navigation to a home portion of the product page. Concepts that define conceptual information about the navigation of the product page are identified and flagged as having limited relation to other information about the product itself. In other words, the navigational word “next” is flagged within the knowledge graph as not defining the product itself, but instead, navigation of the product page.

Creation of the knowledge graph may additionally and/or alternatively include identifying relationships between the entities. In some approaches, these relationships be defined based on “has-feature” relationships between entities. In some other approaches, these relationships may additionally and/or alternatively be defined by “is-part-of” relationships between the entities. In some other approaches, these relationships may additionally and/or alternatively be defined by “enables” relationship two or more different entities. The identified relationships are then, in some preferred approaches, represented as edges in the knowledge graph.

In some approaches, the knowledge graph is constructed such that core concepts of the product are defined as entities in the knowledge graph. For context, in some approaches, these concepts include features of the product, e.g., available selection options on the product page of the product, services associated with and offered for the product, etc. In some other approaches, these concepts may additionally and/or alternatively include functionalities of the product, e.g., software testing functionalities, product ordering functions, etc., In yet some other approaches, these concepts may additionally and/or alternatively include components of the product, e.g., software version, hardware associated with use of the product, etc.

A technical effect of having a plurality of concepts includes a diversification of the knowledge graph and refinement of an accuracy of the validation of translations (based on the plurality of concepts considered for context).

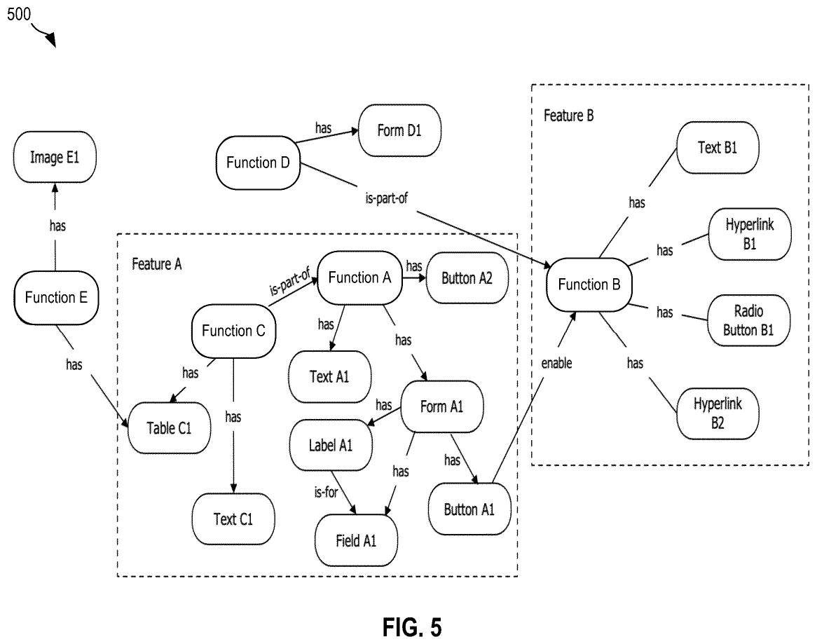

It should be noted that the knowledge graph, in some approaches, is a virtual knowledge graph (VKG), such as ontology-based data access (OBDA). Note that examples of such edge representations of the identified relationships within a virtual knowledge graph are described in greater detail elsewhere herein, e.g., see FIG. 5.

Although the knowledge graph is, in some approaches, described to include the information about the product detailed in operation 202 (and also elsewhere herein), in some approaches, the knowledge graph may additionally include information about a plurality of products. Indexing may be used to separate information pertaining to different products. This way, associated information may be identified within the knowledge graph and used when analyzing the translation of resources associated with a particular product.

A technical effect of creation of the knowledge graph includes organization of information that is referenced by the fine-tuned LLM as context to validate translations of resources. As a result of incorporation of this context to such a validation, inaccurate translations (as a result of mis-context) are able to be identified, rather than being allowed to proceed in a use case environment. Otherwise allowing these mistranslations to proceed would otherwise result in confusion during use of the product, which ultimately leads to additional computer processing being performed to identify the inaccuracies. Accordingly, the creation of the knowledge graph enables a reduction in computer processing associated with translating products such as software products.

Operation 208 includes retrieving, from a knowledge graph, first information associated with first resources in a source language. The first information that is retrieved preferably provides context as to how the first portion of the first resources are typically used with respect to the product and/or the product page. More specifically, in some approaches, the first information is retrieved to serve as a collection of context that may be drawn on during analysis of a translation of the first resources.

For context, the retrieval may, in some approaches, be performed in response to a determination that at least a first portion of the first resources have been translated from the source language to the target language. Note that, for some descriptive purposes below, the at least first portion of the first resources that have been translated from the source language to the target language may also be referred to herein as a “first translation element”. To provide further context, in some approaches, the first resources include a plurality of portions including the first portion.

In some approaches, in addition and/or alternatively to extracting translatable elements and/or entities and text content from the first resources (of the product page) in the source language, translatable elements and/or entities and text content from the translated language page(s) may also be extracted (the page(s) that include the first translation element). Preestablish mechanisms may be used to query the knowledge graph and retrieve relevant information for the translation validation process. In some approaches, the extractions performed from the knowledge graph and/or source pages may utilize a combination of techniques depending on the format of the product pages which may be user interface pages and/or screenshots. For example, these techniques, in some approaches, include computer vision and image processing for extracting data from product page screenshots or images. In some other approaches, this extraction and/or analysis of the information may additionally and/or alternatively be performed using Natural Language Processing (NLP) for extracting textual content from product page HTML and/or other structured formats. In yet some other approaches, these techniques may additionally and/or alternatively include optical character recognition (OCR) for extracting text from product page images or Portable Document Formats (PDFs). These techniques may, in some approaches, return query hits on corresponding nodes within the knowledge graph, and information (within the knowledge graph) associated with the nodes may be extracted.

In some preferred approaches, the first information includes strings of words that define relationships that the first portion of the first resources has with other portions of the first resources. In one or more of such approaches, the first information includes subject-predicate-object strings. Accordingly, in some approaches, operation 208 includes retrieving relevant triples (subject-predicate-object) and related information (e.g.: node attributes and/or descriptions) from the knowledge graph for each extracted element or entity.

These strings may be points located along a path of the knowledge graph in some approaches, e.g., see FIG. 5 in which strings of points are aligned along different paths of a virtual knowledge graph. The strings are associated with the portions. Examples of how these strings may define the relationship the first portion of the first resources has with a second portion of the first resources includes a string that includes “Form A1, has, Label A1”. Assuming that the first portion includes the Form A1, this string of words indicates that the first portion has a label that a second portion of the first resources may also have and/or depend on.

In order to ensure that the first translation element is validated by a context provided from the knowledge graph, one or more operations for achieving knowledge graph integration may be performed, in some approaches (as will be described below). These operations integrate the product knowledge graph into a translation validation workflow, making information of the knowledge graph accessible to an LLM-based translation consistency validation system.

A technical effect of the first information including subject-predicate-object strings that are associated with the portions includes establishment of a concise description of context, that is uniform for each of the different portions. The conciseness of the first information (in the form of subject-predicate-object strings) also has a technical effect of ensuring that a storage size of first information is predictable when scaling-out the knowledge graph.

Operation 210 of method 200 includes using the first information to generate sentences that detail a context of the first resources and relationships that the first resources have with second resources. Techniques that would become apparent to one or ordinary skill in the art after reading the descriptions herein may be used to generate sentences from the first information. In some approaches, predefined templates are applied to use the first information to generate the sentences that detail the context of the first resources and the relationships that the first resources have with the second resources. For example, the triples (the subject-predicate-object strings) may be converted into natural language sentences using predefined templates (which in some approaches are called Triple-to-Sentence Templates (TST)). These sentences effectively capture the context and relationships associated with the first portion of the first resources and/or the translation elements. It may be prefaced that these converted sentences may be easily and accurately understood by an LLM for reasoning described in subsequent steps below, e.g. see operation 212.

A technical effect of using predefined templates to generate the sentences from the first information includes a reduction in an amount of processing that is consumed (such as by an artificial intelligence (AI) model used to generate the sentences) in generating the sentences. In other words, the predefined templates serve as a guide for how to generate the sentences rather than the sentences being generated without any such guidance.

The generated sentences are preferably used by the fine-tuned LLM to generate a grade for validating a translation of the first translation element (where the first translation elements is a translation of a first portion of the first resources from the source language to the target language). Accordingly, in some preferred approaches, method 200 includes causing the fine-tuned LLM to use the generated sentences to grade the first translation element, e.g., see operation 212. In order to cause the fine-tuned LLM to use the generated sentences to generate such a grade, in some approaches, method 200 includes sending the sets of sentences generated in previous step to the fine-tuned LLM and instructing the fine-tuned LLM to characterize e.g., via natural language descriptions, via scoring the translation, via textually summarizing an issue with the translation, etc., the translation. Depending on the approach, in addition to the sentences the fine-tuned LLM may have access to and/or be fed any of the other extracted information from the translated product pages, LLM-generated context descriptions, and/or other information described herein.

Contextual translation validation of the first translation element is preferably performed based on the grade output by the fine-tuned LLM. This way, the LLM's understanding of the product-specific context is leveraged to assess the accuracy and appropriateness of the translations of the first resources (and more specifically the first translation element in the current approach).

In some approaches, the grade of the fine-tuned LLM includes a numerical score. The numerical score is, in some approaches, based on a specific factor associated with a product page associated with the first resources. In some of these approaches the specific factor includes a linguistic style of the product page. In some other approaches, the specific factor additionally and/or alternatively includes conventions of the product page. In yet another approach, the specific factor additionally and/or alternatively includes a tone of the product page (an average review exceeding a predetermined threshold indicates that translations of previous portions of the first resources are accurate and understood by users of the product page). In some other approaches, the specific factor additionally and/or alternatively includes an overall historical user experience of the product page (incorporates negative reviews on the product page that indicate which elements have previously been translated incorrectly and/or where confusion arises from).

A technical effect of using a numerical score for validating a translation includes establishment of a uniform threshold that each translation element is gauged against. Furthermore, a technical effect of having a plurality of factors that the numerical score is based on includes the addition of detail and diversification into the grade of the first translation element.

In some approaches, the grade of the fine-tuned LLM includes additionally and/or alternatively includes natural language descriptions detailing the grade. These natural language descriptions, in some approaches, detail an alternative definition of the first translation element, e.g., a suggested alternative and reasons why the suggested alternative is contextually more accurate than the first translation element.

In one use case approach, the grade of the fine-tuned LLM includes a translation quality score and includes suggestions for improvements based on the identified discrepancies between the translated content and the expected context.

Operation 214 includes using the grade to validate (check and/or refine a validity of) the first translation element. In one use case example, validation of the first translation element includes evaluating the quality score. For example, in some approaches, method 200 includes determining whether the numerical score exceeds a predetermined validation threshold, and in response to a determination that the numerical score does not exceed the predetermined validation threshold, determining a replacement translation element to replace the first translation element with. Determination of the replacement translation element, in some approaches, includes adjusting the translation to align with the product's linguistic style, conventions, and overall user experience. Cross-referencing the translations with the context information extracted from knowledge graph may, in some approaches, be used to identify any discrepancies or inconsistencies in terminology, tone, or style. In contrast, in response to a determination that the numerical score exceeds or matches the predetermined validation threshold, a replacement translation element is not determined, and the first translation element is used.

Method 200, in some approaches, includes refining an accuracy of the fine-tuned LLM over time in order to reduce an overall amount of work that is performed when validating a translation element (this also increases a work potential of a user device performing operations described herein). In some approaches this refinement includes fine-tuning the knowledge graph over time. Accordingly, the creating the knowledge graph may, in some approaches, comprise enriching the knowledge graph. For context, in some approaches, the enriching includes adding attributes specific to the product page to the knowledge graph. In some approaches, the attributes Hypertext Markup Language (HTML) attributes of a type that would become apparent to one of ordinary skill in the art after reading the descriptions herein. The attributes may additionally and/or alternatively include technical specifications, in some other approaches. Use cases of a type that would become apparent to one of ordinary skill in the art after reading the descriptions herein are other potential attributes. Furthermore, performance characteristics of a type that would become apparent to one of ordinary skill in the art after reading the descriptions herein may be used at the attributes.

Operation 216 includes performing a refinement process on the knowledge graph to increase an accuracy of the fine-tuned LLM over time. In some approaches, the refinement process is iteratively performed on the knowledge graph to increase an accuracy of the fine-tuned LLM over time. The iteratively performing the refinement process on the knowledge graph, in some approaches, comprises employing rule-based reasoning and consistency checking mechanisms to validate an integrity and coherence of the knowledge graph. The rule-based reasoning and consistency checking mechanisms may be of a type that would become apparent to one of ordinary skill in the art after reading the descriptions herein. A technical effect of increasing an accuracy of the fine-tuned LLM over time includes reducing an overall amount of work that is performed when validating a translation element. This also increases a work potential of a user device performing operations described herein.

A technical effect of using the techniques method 200 to determine and incorporate contextual relationships of resources during the process of using an LLM to translate resources from a source language to a target language includes streamlining into the translation of the resources. This contextual validation also increases the accuracy and performance of machine translation for software interfaces because manual errors are not introduced to the translation as the techniques described herein do not involve manual intervention.

In some approaches, the operations of method 200 may be performed by an AI model that is trained using a predetermined training set of data. For example, in some approaches, various of the operations noted above may be deployed in a trained state of a trained AI model. Training of the AI model, in some approaches, may be performed by applying a predetermined training data set to learn how to use context to validate a translation element. Initial training may include reward feedback of a type that would become apparent to one of ordinary skill in the art after reading the descriptions herein. However, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 200 may be performed. In some further approaches, the AI model may be a neuromyotonic AI model that may improve performance of computer devices in an infrastructure associated with product pages and translations, because the neuromyotonic AI model may not need an SME and/or iteratively applied training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received from user devices. Such an AI model ensures that translations are streamlined and efficient, where the scale of such analysis and determinations would not otherwise be feasible for a human to perform. This is because humans are not able to efficiently use the information of a scaled-out knowledge base, and would otherwise incorporate processing delays and errors in validations of translation elements in the process of attempting to do so. Accordingly, management of operations described herein is not able to be achieved by human manual actions.

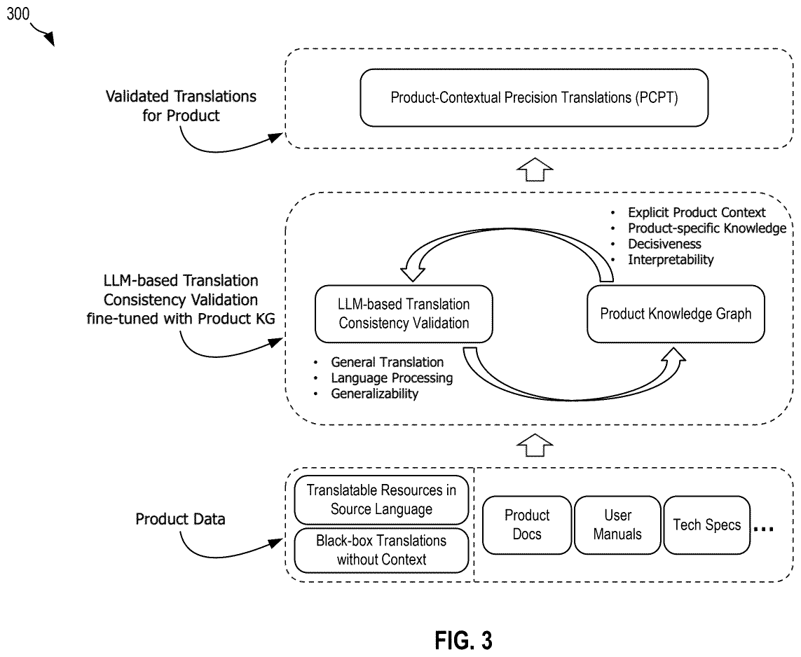

FIG. 3 depicts a logical framework 300, in accordance with one approach. As an option, the present logical framework 300 may be implemented in conjunction with features from any other approach listed herein, such as those described with reference to the other FIGS. Of course, however, such logical framework 300 and others presented herein may be used in various applications and/or in permutations which may or may not be specifically described in the illustrative approaches listed herein. Further, the logical framework 300 presented herein may be used in any desired environment.

The logical framework 300 details an LLM-based translation consistency validation system that is fine-tuned with a product knowledge graph. The logical framework 300 uses product data to generate a knowledge graph (KG). Advantages of the LLMs and knowledge graph may be combined using the techniques of method 200 in order to enable translation validation capabilities of LLMs. These capabilities are enhanced with semantic interpretability for specific product context. For example, in some approaches, these capabilities may be used to validate translation elements for software products, e.g., see validated translations for product, which may also be referred to as “Product-Contextual Precision Translations (PCPT)”.

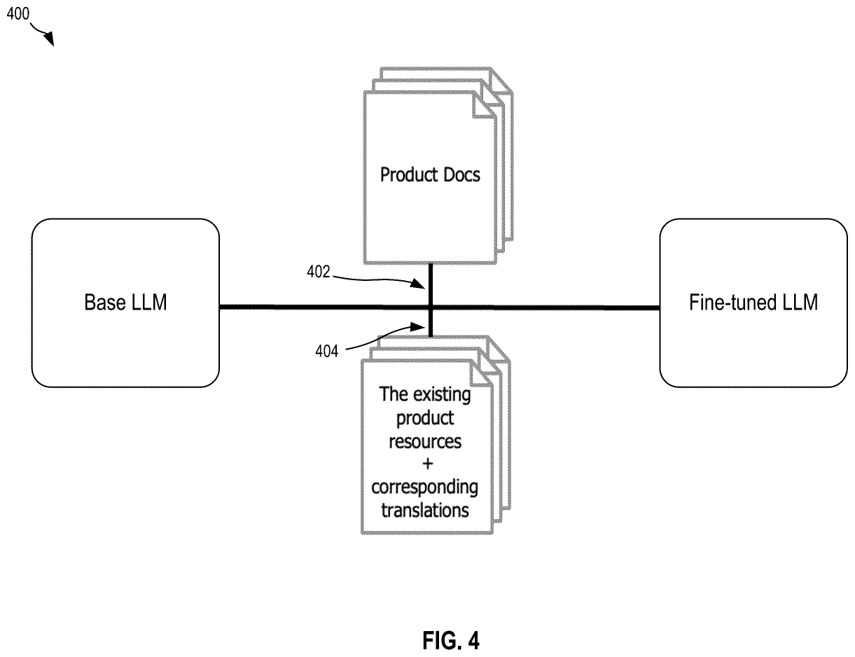

Now referring to FIG. 4, a flowchart of a method 400 is shown according to one approach. The method 400 may be performed in accordance with aspects of the present invention in any of the environments depicted in FIGS. 1-8, among others, in various approaches. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various approaches, the method 400 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

Method 400 includes operations for fine-tuning an LLM to enhance recognition of product-specific knowledge and translatable content. More specifically, in flowchart of method 400, the model tuning is targeted. In order for the large language model (LLM) to better complete the steps and processing post fine-tuning, information about the product is used to train a base LLM. For example, operations 402 and 404 include incorporating product documents determined to be relevant, product translatable resource files, and translated content to enhance and fine-tuning the base LLM's recognition of product-specific knowledge and translatable content. A result of the training includes a fine-tuned LLM.

FIG. 5 depicts a knowledge graph 500, in accordance with one approach. As an option, the present knowledge graph 500 may be implemented in conjunction with features from any other approach listed herein, such as those described with reference to the other FIGS. Of course, however, such knowledge graph 500 and others presented herein may be used in various applications and/or in permutations which may or may not be specifically described in the illustrative approaches listed herein. Further, the knowledge graph 500 presented herein may be used in any desired environment.

In order to enable translation validation capabilities of LLMs for software products, the knowledge graph is created. In the process of creating the knowledge graph, a focus may include extracting main entities, related attributes and information of translatable content from preprocessed data. The extracted information is, in some preferred approaches, specific to a first type of product such that the knowledge graph may be a dedicated product knowledge graph (PKG) for the product. The knowledge graph may then be applied in a subsequent translation validation process to supply context information.

The knowledge graph illustrates several functions and user interface elements contained in the different features, e.g., see “Function B” has “Text B1”, “Hyperlink B1”, etc. Relationships between functions and features are also detailed in the knowledge graph, e.g., see “has”, “is-for”, etc.

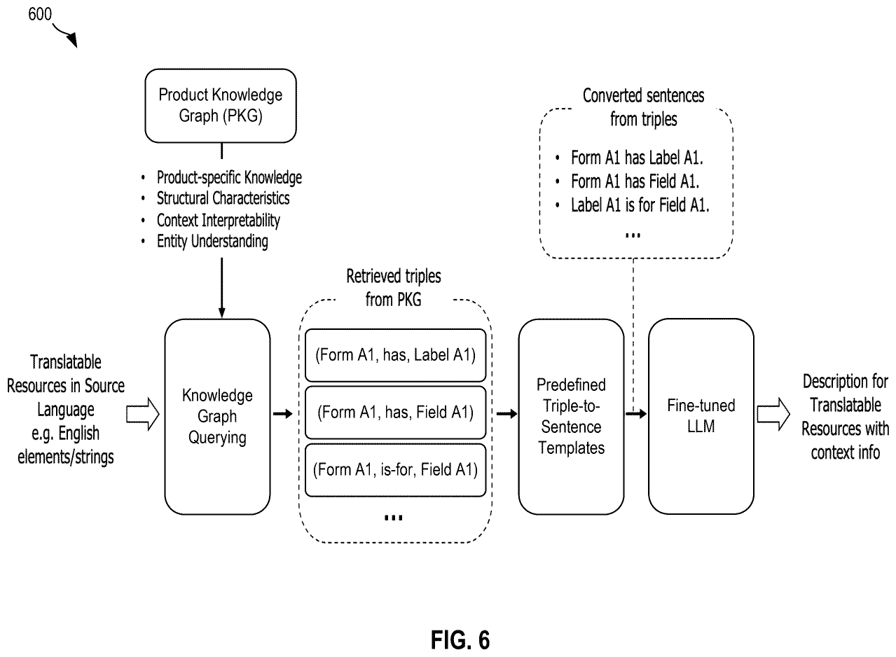

Now referring to FIG. 6, a flowchart of a method 600 is shown according to one approach. The method 600 may be performed in accordance with aspects of the present invention in any of the environments depicted in FIGS. 1-8, among others, in various approaches. Of course, more or fewer operations than those specifically described in FIG. 6 may be included in method 600, as would be understood by one of skill in the art upon reading the present descriptions.

Each of the steps of the method 600 may be performed by any suitable component of the operating environment. For example, in various approaches, the method 600 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 600. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 600 details that after obtaining information about a product page, the descriptive text containing context information about the product may be obtained through predetermined processing operations. In some approaches, a first part of these predetermined processing operations are based on knowledge graph querying and context generation. For example, these operations, in some approaches, include leveraging a pre-constructed product knowledge graph to find the corresponding nodes for the extracted data from the source language product pages. Relevant triples (subject-predicate-object) and related information (e.g.: node attributes or descriptions) may be retrieved from the product knowledge graph for each extracted element or entity, e.g., see retrieved triples from PKG. The triples are, in some approaches, converted into natural language sentences using predefined templates which may be referred to as Triple-to-Sentence Templates (TST). These sentences effectively capture the context and relationships associated with the page elements. Furthermore, these converted sentences may be understood easily and accurately by a fine-tuned LLM for reasoning in subsequent operations described below.

The subsequent operations, in some approaches, are based on LLM-based context description generation. These operations may, in some approaches, include sending the sets of sentences generated in previous operations to the fine-tuned LLM. In some approaches, the LLM may be used to generate concise, natural language descriptions that summarize the context and meaning of the page elements or entities, e.g., see Description for Translatable Resources with context info.

With continued reference to FIG. 6, querying may be performed on a knowledge graph, and after obtaining the information of the ‘Label A1’ element on a product page, through these steps and methods, the description content containing the context information of this element is obtained. More specifically, the label A1's text is used to describe field A1, and both label A1 and field A1 belong to the form A1.

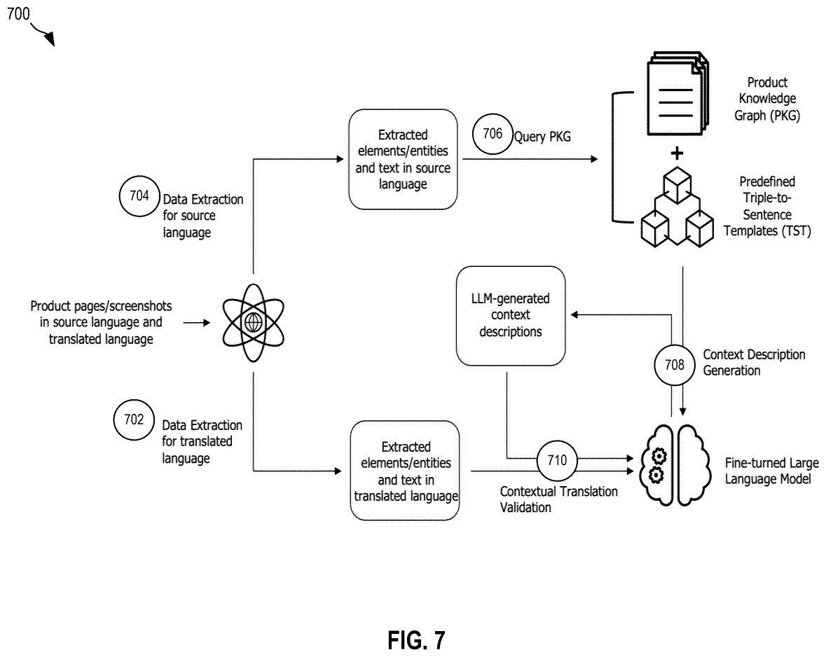

Now referring to FIG. 7, a flowchart of a method 700 is shown according to one approach. The method 700 may be performed in accordance with aspects of the present invention in any of the environments depicted in FIGS. 1-8, among others, in various approaches. Of course, more or fewer operations than those specifically described in FIG. 7 may be included in method 700, as would be understood by one of skill in the art upon reading the present descriptions.

Each of the steps of the method 700 may be performed by any suitable component of the operating environment. For example, in various approaches, the method 700 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 700. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 700 includes an overview of operations described herein in processes of contextual translation validation integrated with a product knowledge graph. For example, in some approaches, these operations include performing data extraction from product pages, e.g., see operations 702 and 704. Note that, in some approaches, a first of the product pages is in the source language, while a second of the product pages is in the target language (pre and post translation). Techniques for extracting information from product pages are described elsewhere herein and may be used for performing the data extraction.

Knowledge graph querying and context generation operations may additionally and/or alternatively be performed, e.g., see operations 706 and 708. Techniques for such querying and generating are described elsewhere herein and may be used.

In some approaches, a fine-tuned LLM may be used to grade a translation of an element of the product page. In some approaches, the grade includes a generated context description that is used to determine whether the translation is valid, e.g., see operation 710.

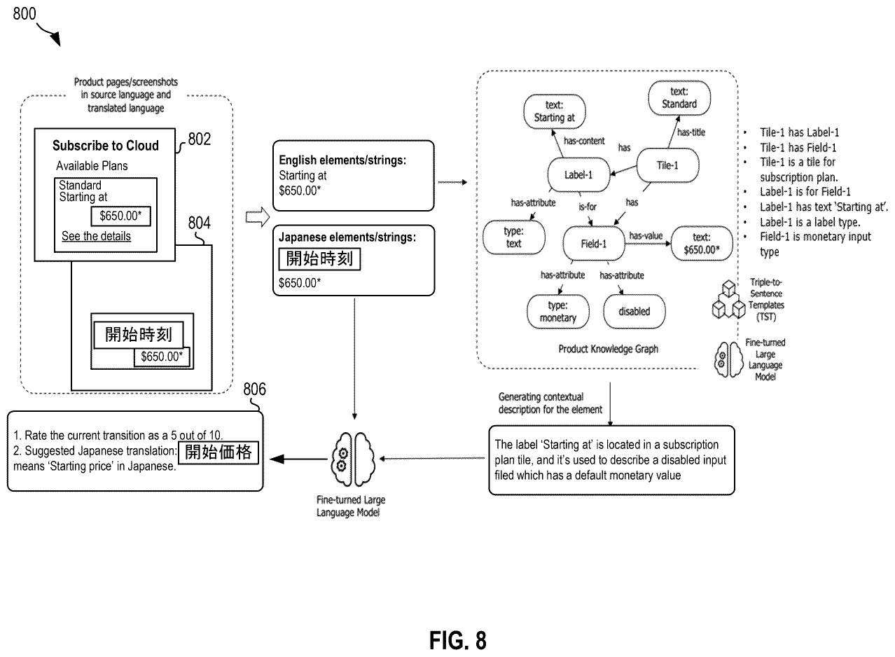

Now referring to FIG. 8, a flowchart of a method 800 is shown according to one approach. The method 800 may be performed in accordance with aspects of the present invention in any of the environments depicted in FIGS. 1-8, among others, in various approaches. Of course, more or fewer operations than those specifically described in FIG. 8 may be included in method 800, as would be understood by one of skill in the art upon reading the present descriptions.

Each of the steps of the method 800 may be performed by any suitable component of the operating environment. For example, in various approaches, the method 800 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 800. Illustrative processors include, but are not limited to, a central processing unit (CPU), an application specific integrated circuit (ASIC), a field programmable gate array (FPGA), etc., combinations thereof, or any other suitable computing device known in the art.

Method 800 details application of the validation techniques described herein for a product page. For example, a first screenshot 802 is a product page that has resources in a source language (English), while a second screenshot 804 is the product page subsequent to textual elements of the resources being translated to a target language (Japanese). More specifically, “Starting at” of the first screenshot is translated into translation element “ [symbol] ” on the second screenshot 804, which means ‘Starting Time’ in Japanese. Based on the contextual information on the interface, it is easy to tell that this translation is incorrect. However, when translating product resource files/bundles during the development process, the plain text content fails to provide a relevant user interface or context information. Accordingly, without using the techniques described herein, a translation is only performed according to the general principles of semantics and therefore experiences the translation error detailed in the screenshots. However, using the techniques described herein, the fine-tuned LLM mitigates such errors by retrieving relevant contextual information from the product knowledge graph, e.g., see Generating contextual description for the element. This way the fine-tuned LLM provide a grade 806 of the translation element, which may include, e.g., a numerical score, a relatively more appropriate and accurate translation suggestion: ‘ [symbol] ’ which means ‘Starting price’ in Japanese, etc.

It should be noted that although the example details a validation performed for a first of the translation elements (based on a translation of “starting at”), in some approaches, these techniques may additionally and/or alternatively be performed with respect to any number of the resources of the product pages.

One technical effect of the validation techniques described herein includes contextual enrichment of LLM-based translation validation. Integrating the product knowledge graph into an LLM-based translation consistency validation system provides rich contextual information that enables the language model to generate more appropriate, accurate, and nuanced translations. The contextual knowledge captured in the product knowledge graph helps the LLM better understand the meaning, relationships, and intended usage of the page elements, leading to improved translation quality and consistency. This technical effect further includes an automated translation quality validation process and greatly improve the efficiency and effectiveness of translation quality validation.

Another technical effect of the validation techniques described herein includes targeted knowledge graph construction. This technical effect leverages the product's relevant documentation, information of user interface and other resources to build a tailored product knowledge graph focused on the translatable content, especially the user interface elements. This targeted approach ensures that the knowledge graph provides relevant and useful contextual information to support the translation validation process, rather than relying on a more general or broad knowledge base.

Yet another technical effect of the validation techniques described herein includes relatively efficient context extraction and transformation. For example, the use of predefined Triple-to-Sentence Templates (TST) in combination with the fine-tuned LLM enables a rapid and accurate extraction of the product's contextual information from the knowledge graph. The transformation of the knowledge graph triples into natural language sentences allows the LLM to seamlessly consume and understand the contextual information, facilitating more effective translation validation.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A method comprising:
retrieving, from a knowledge graph, first information associated with first resources in a source language;
using the first information to generate sentences that detail a context of the first resources and relationships that the first resources have with second resources;
causing a fine-tuned large language model (LLM) to grade a first translation element, wherein the first translation element is a translation of a first portion of the first resources to a target language; and
using the grade to validate the first translation element.

2. The method of claim 1, further comprising:
creating the fine-tuned LLM, wherein creating the fine-tuned LLM includes:
obtaining second information for a product page associated with the first resources,
wherein the second information is selected from the group consisting of:
documents, existing resources, and previously performed corresponding translations; and
using the second information to tune a base LLM to create the fine-tuned LLM.

3. The method of claim 2, wherein the first resources include a plurality of portions including the first portion, wherein the first information includes subject-predicate-object strings, wherein the strings are associated with the portions.

4. The method of claim 3, wherein predefined templates are applied to use the first information to generate the sentences that detail the context of the first resources and the relationships that the first resources have with the second resources.

5. The method of claim 1, further comprising:
creating the knowledge graph, wherein the creating the knowledge graph comprises:
defining concepts of a product page associated with the first resources as entities in the knowledge graph;
identifying relationships between the entities; and
representing the identified relationships as edges in the knowledge graph.

6. The method of claim 5, wherein the creating the knowledge graph further comprises:
enriching the knowledge graph,
wherein the enriching includes adding attributes specific to the product page to the knowledge graph,
wherein the attributes are selected from the group consisting of: Hypertext Markup Language (HTML) attributes, technical specifications, use cases, and performance characteristics.

7. The method of claim 5, wherein the concepts are selected from the group consisting of: features, functionalities, and components, wherein the knowledge graph is a virtual knowledge graph.

8. The method of claim 1, wherein the grade of the fine-tuned LLM includes a numerical score and natural language descriptions detailing the grade, and further comprising:
determining whether the numerical score exceeds a predetermined validation threshold; and
in response to a determination that the numerical score does not exceed the predetermined validation threshold, determining a replacement translation element to replace the first translation element with.

9. The method of claim 8, wherein the numerical score is based on a specific factor associated with a product page associated with the first resources, wherein the specific factor is selected from the group consisting of: a linguistic style of the product page, conventions of the product page, a tone of the product page, and an overall historical user experience of the product page.

10. The method of claim 1, further comprising:
iteratively performing a refinement process on the knowledge graph to increase an accuracy of the fine-tuned LLM over time,
wherein the iteratively performing the refinement process on the knowledge graph comprises: employing rule-based reasoning and consistency checking mechanisms to validate an integrity and coherence of the knowledge graph.

11. A computer program product comprising:
one or more computer-readable storage media; and
program instructions stored on the one or more storage media to perform operations comprising:
retrieving, from a knowledge graph, first information associated with first resources in a source language;
using the first information to generate sentences that detail a context of the first resources and relationships that the first resources have with second resources;
causing a fine-tuned large language model (LLM) to grade a first translation element, wherein the first translation element is a translation of a first portion of the first resources to a target language; and
using the grade to validate the first translation element.

12. The computer program product of claim 11, wherein the operations further comprise:
creating the fine-tuned LLM, wherein creating the fine-tuned LLM includes:
obtaining second information for a product page associated with the first resources,
wherein the second information is selected from the group consisting of:
documents, existing resources, and previously performed corresponding translations; and
using the second information to tune a base LLM to create the fine-tuned LLM.

13. The computer program product of claim 12, wherein the first resources include a plurality of portions including the first portion, wherein the first information includes subject-predicate-object strings, wherein the strings are associated with the portions.

14. The computer program product of claim 11, wherein the operations further comprise:
creating the knowledge graph, wherein the creating the knowledge graph comprises:
defining concepts of a product page associated with the first resources as entities in the knowledge graph;
identifying relationships between the entities; and
representing the identified relationships as edges in the knowledge graph.

15. The computer program product of claim 14, wherein the creating the knowledge graph further comprises:
enriching the knowledge graph,
wherein the enriching includes adding attributes specific to the product page to the knowledge graph,
wherein the attributes are selected from the group consisting of: Hypertext Markup Language (HTML) attributes, technical specifications, use cases, and performance characteristics.

16. The computer program product of claim 14, wherein the concepts are selected from the group consisting of: features, functionalities, and components, wherein the knowledge graph is a virtual knowledge graph.

17. The computer program product of claim 11, wherein the grade of the fine-tuned LLM includes a numerical score and natural language descriptions detailing the grade, wherein the operations further comprise:
determining whether the numerical score exceeds a predetermined validation threshold; and
in response to a determination that the numerical score does not exceed the predetermined validation threshold, determining a replacement translation element to replace the first translation element with.

18. The computer program product of claim 17, wherein the numerical score is based on a specific factor associated with a product page associated with the first resources, wherein the specific factor is selected from the group consisting of: a linguistic style of the product page, conventions of the product page, a tone of the product page, and an overall historical user experience of the product page.

19. The computer program product of claim 11, wherein the operations further comprise:
iteratively performing a refinement process on the knowledge graph to increase an accuracy of the fine-tuned LLM over time,
wherein the iteratively performing the refinement process on the knowledge graph comprises: employing rule-based reasoning and consistency checking mechanisms to validate an integrity and coherence of the knowledge graph.

20. A computer system comprising:
a processor set;
one or more computer-readable storage media; and
program instructions stored on the one or more storage media to cause the processor set to perform operations comprising:
retrieving, from a knowledge graph, first information associated with first resources in a source language;
using the first information to generate sentences that detail a context of the first resources and relationships that the first resources have with second resources;
causing a fine-tuned large language model (LLM) to grade a first translation element, wherein the first translation element is a translation of a first portion of the first resources to a target language; and
using the grade to validate the first translation element.
